(19) United States
(12) Patent Application Publication
(10) Pub. No.: US 2012/0129061 A1
(43) Pub. Date: May 24, 2012

(54) DEVICE FOR REMOVING GENERATED WATER

(75) Inventors: Masato Nishikawa, Kumagaya-shi (JP); Takahiro Nakamura, Kumagaya-shi (JP)

(73) Assignee: SANYO ELECTRIC CO., LTD., Moriguchi-shi, Osaka (JP)

(21) Appl. No.: 13/388,217

(22) PCT Filed: Mar. 16, 2010
(86) PCT No.: PCT/JP2010/001863

§ 371 Date: Jan. 31, 2012

(30) Foreign Application Priority Data
Jul. 31, 2009 (JP) 2009-180089

(51) Int. Cl. H01M 8/06

(52) U.S. Cl. 429/414

(57) ABSTRACT

Generated water generated from electrical equipment such as a fuel cell or the like is surely and quickly removed. A generated water removing device 10 has a diaphragm 14 that is disposed so as to face a generated water discharge face 11A of a fuel cell 11 through a predetermined first gap L1, has plural holes 13 for atomizing or vaporizing generated water and feeds generated water to the outside of the first gap L1 through the holes 13, and a heat pipe 17 that has a heat absorber 15 for absorbing heat generated in the fuel cell 11 and a heat radiator 16 disposed so as to face the diaphragm 14 through a predetermined second gap L2, and transfers heat absorbed by the heat absorber 15 to the heat radiator 16 to warm the generated water fed to the outside of the first gap through the holes 13.

### TECHNICAL FIELD

The present invention relates to a device for removing generated water, and particularly to a generated water removing device that can quickly and surely remove generated water produced when a fuel cell generates electric power.

### BACKGROUND ART

Attention has been hitherto paid to fuel cells as energy sources for various kinds of electric/electronic equipment because the fuel cells have high energy conversion efficiencies and also generate no harmful substance through power generating reactions.

A unit cell constituting a fuel cell has an electrolytic layer and an oxidant electrode and a fuel electrode disposed at both the sides of the electrolytic layer to form a membrane electrode assembly (MEA).

Here, the unit cell contains an oxidant electrode side electrical conductive plate having plural air supply grooves which are concaved so as to cover the surface of the oxidant electrode constituting the membrane electrode assembly. Furthermore, the unit cell contains a gas separator disposed outside the oxidant electrode side electrical conductive plate.

Furthermore, the unit cell contains a fuel electrode side electrical conductive plate having plural fuel gas supply grooves which are concaved so as to cover the surface of the fuel electrode constituting the membrane electrode assembly.

In the thus-constructed fuel cell, air is fed into the air supply grooves of the oxidant electrode side electrical conducive plate, and fuel gas is fed into the fuel gas supply grooves of the fuel electrode side electrical conductive plate, whereby power generation is performed.

It has been recently considered that a fuel cell is mounted as a power source in compact electronic equipment.

For example, a direct methanol type fuel cell (DMFC) which can be configured to be thinner attracts much attention as such a fuel cell as described above. In DMFC, oxidized gas such as air, oxygen or the like is supplied to the oxidant electrode, and fuel such as methanol or the like is supplied to the fuel electrode in the form of gas or liquid to perform power generation.

However, in order to mount a fuel cell in compact electronic equipment, when air (oxygen) is supplied as oxidant to the oxidant electrode, a gas supply device for supplying the oxidant is required to be miniaturized.

A device for supplying gas by vibrating a fuel cell has been disclosed as a compact gas supply device (see Patent Document 1 and Patent Document 2, for example). The Patent Document 1 proposes a gas jetting device for jetting gas by using plural chambers constructed by vibrators. Furthermore, the Patent Document 2 proposes a fuel cell having vibration applying means for vibrating an oxidant electrode, a fuel electrode, a separator, etc.

### PRIOR ART DOCUMENT

### Patent Document

Patent Document 1: JP-A-2005-243496

Patent Document 2: JP-A-2002-203585

### SUMMARY OF THE INVENTION

### Problem to be Solved by the Invention

With respect to a fuel cell, water is generated in the process of power generation. However, when generated water (generated water) is not well discharged to the outside, it disturbs vibration of a vibrator or directly disturb supply of oxidant, so that efficient power generation cannot be performed.

As a result, there occurs a disadvantage that an operable time of portable electronic equipment containing a fuel cell is shortened or the like. Likewise, in an electrical device (electrical equipment) in which water is generated under operation, the generated water induces a trouble in the operation of the device.

Therefore, an object of the present invention is to provide a generated water removing device that surely and quickly removes generated water generated by electrical equipment (electrical equipment) such as a fuel cell or the like.

### Means of Solving the Problem

In order to solve the problem, according to the present invention, a generated water removing device for removing generated water generated from electrical equipment (electronic equipment) is characterized by comprising: a diaphragm that is disposed so as to face a generated water discharge face of the electrical equipment through a predetermined first gap, has a plurality of holes for atomizing or vaporizing the generated water and feeds the generated water to the outside of the first gap through the holes; and a heat pipe that has a heat absorber for absorbing heat generated in the electrical equipment and a heat radiator disposed so as to face the diaphragm through a predetermined second gap, and transfers heat absorbed by the heat absorber to the heat radiator to warm the generated water fed to the outside of the first gap through the holes.

According to the above construction, the diaphragm feeds the generated water to the outside of the first gap through the plural holes for atomizing or vaporizing the generated water.

The heat pipe transfers the heat absorbed by the heat absorber to the heat radiator, and warms the generated water fed to the outside of the first gap through the holes.

Accordingly, the generated water can be surely and quickly removed by using the heat generated in the electrical equipment.

Furthermore, according to the present invention, a generated water removing device for removing generated water generated when power is generated by a fuel cell is characterized by comprising: a diaphragm that is disposed so as to face an oxidant electrode side housing of the fuel cell through a predetermined first gap, has a plurality of holes for atomizing or vaporizing the generated water and feeds the generated water to the outside of the first gap through the holes; and a heat pipe that has a heat absorber for absorbing heat generated at a fuel electrode side of the fuel cell and a heat radiator disposed so as to face the diaphragm through a predetermined second gap, and transfers heat absorbed by the heat absorber to the heat radiator to warm the generated water fed to the outside of the first gap through the holes.

According to the above construction, the diaphragm feeds the generated water to the outside of the first gap through the plural holes for atomizing or vaporizing the generated water.

The heat pipe transfers the heat absorbed by the heat absorber to the heat radiator, and warms the generated water fed to the outside of the first gap through the holes.

Accordingly, the generated water can be surely and quickly removed by using the heat which is generated through power generation by the fuel cell.

Furthermore, according to the present invention, a generated water removing device for removing generated water generated when power is generated by a fuel cell contained in portable electronic equipment is characterized by comprising: a diaphragm that is disposed so as to face an oxidant electrode side housing of the fuel cell through a predetermined first gap, has a plurality of holes for atomizing or vaporizing the generated water and feeds the generated water to the outside of the first gap through the holes; and a heat pipe that has a heat absorber for absorbing heat generated in a heat source device constituting the portable electronic equipment and a heat radiator disposed so as to face the diaphragm through a predetermined second gap, and transfers heat absorbed by the heat absorber to the heat radiator to warm the generated water fed to the outside of the first gap through the holes.

According to the above construction, the diaphragm feeds the generated water to the outside of the first gap through the plural holes for atomizing or vaporizing the generated water.

The heat pipe transfers the heat absorbed by the heat absorber to the heat radiator, and warms the generated water fed to the outside of the first gap through the holes.

Accordingly, the generated water can be surely and quickly removed by using the heat which occurs in the heat source device constituting the portable electronic equipment.

In this case, a generated water feeding path may be constructed by the diaphragm and a portion of the heat pipe that faces the diaphragm, and a cross-sectional area of the generated water feeding path may be gradually or stepwise increased along a feeding direction of the generated water.

According to the above construction, the generated water which is atomized or vaporized and warmed in the generated water feeding path is fed in the generated water feeding path with being diffused.

Still furthermore, the generated water may be fed to the outside of the generated water feeding path by an acoustic stream that is generated in the generated water feeding path due to vibration of the diaphragm and reflection of the heat radiator of the heat pipe.

According to the above construction, the acoustic stream is generated in the generated water feeding path, so that the generated water is quickly fed and thus the generate water in the first gap is quickly fed to the outside of the generated water feeding path.

Still furthermore, the heat radiator of the heat pipe may have a plurality of heat radiation fins projecting into the second gap.

According to the above construction, the heat is efficiently transferred, and the generated water is quickly fed.

Still furthermore, a surface of the heat radiator of the heat pipe that is located at the diaphragm side may be formed of a hydrophilic material.

According to the above construction, generated water fed to the outside of the first gap easily adheres to the heat radiator of the heat pipe, and thus the generated water is efficiently warmed and thus quickly fed.

### Effect of the Invention

According to the present invention, generated water which is generated from electrical equipment such as a fuel cell or the like can be surely and quickly removed, and thus the operation of the electrical equipment can be smoothly performed.

### BRIEF DESCRIPTION OF THE DRAWINGS

FIG. 1 is a diagram showing the principle of a generated water removing device according to an embodiment.

FIG. 2 is a diagram showing the construction of a portable fuel cell unit having the generated water removing device according to a first embodiment. FIG. 2(a) is a cross-sectional view showing the fuel cell unit containing a discharge path for generated water which is atomized or vaporized. FIG. 2(b) is a cross-sectional view taken along A-A of FIG. 2(a).

FIG. 3 is a perspective view showing the outlook of a heat pipe.

FIG. 4 is a diagram showing a method of thermally connecting the heat pipe to the fuel cell. FIG. 4(a) is a diagram showing a first method, and FIG. 4(b) is a diagram showing a second method.

FIG. 5 is a diagram showing the principle of acoustic stream.

FIG. 6 is a diagram showing the construction of the fuel cell.

FIG. 7 is a diagram (part 1) showing frequency variation of a piezoelectric element.

FIG. 8 is a diagram (part 2) showing the frequency variation of the piezoelectric element.

FIG. 9 is a functional block diagram showing the fuel cell unit according to the first embodiment.

FIG. 10 is a flowchart showing control processing of the fuel cell. FIG. 10(a) is a processing flowchart of an UP mode, and FIG. 10(b) is a processing flowchart of a DOWN mode.

FIG. 11 is a diagram (part 3) showing the frequency variation of the piezoelectric element.

FIG. 12 is a diagram showing a second embodiment. FIG. 12(a) is a cross-sectional view showing the fuel cell unit containing a discharge passage for generated water which is atomized or vaporized. FIG. 12(b) is a B-B cross-sectional view of FIG. 12(a).

FIG. 13 is a diagram showing a third embodiment.

FIG. 14 is a diagram showing a foldable portable cellular phone terminal in which a fuel cell having generated water removing device according to the present invention is mounted.

FIG. 15 is a diagram showing a case where the fuel cell is secured to the portable cellular phone.

FIG. 16 is an exploded perspective view showing the fuel cell unit mounted in a cover.

FIG. 17 is a partial assembling diagram when the fuel cell unit is mounted in the cover.

FIG. 18 is a diagram showing acoustic pressure. FIG. 18(a) is a diagram showing an acoustic pressure distribution in a predetermined direction along an oxidant supply passage under the state that no water droplet adheres to a diaphragm, and FIG. 18(b) is a diagram showing an acoustic pressure distribution in the same direction as the predetermined direction under the state that water droplets adhere to the diaphragm.

### MODES FOR CARRYING OUT THE INVENTION

An embodiment according to the present invention will be described hereunder with reference to the drawings.

### [1] Description of Principle

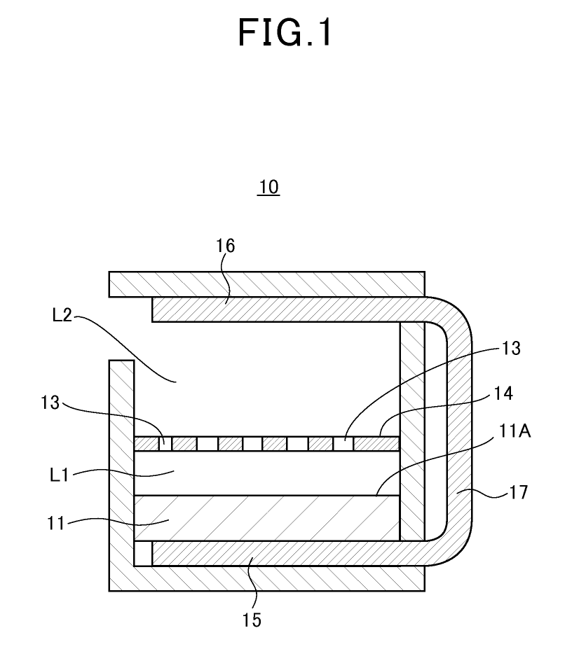

FIG. 1 is a diagram showing the principle of a generated water removing device according to an embodiment.

a generated water removing device 10 removes generated water which is generated by a fuel cell 11 as an electrical device (electrical equipment).

The generated water removing device 10 has plural holes 13 which are disposed so as to be spaced from a generated water discharge face 11A of a fuel cell 11 through a predetermined first gap L1 and atomize or vaporize generated water. Furthermore, the generated water removing device 10 has a diaphragm 14 for feeding generated water to the outside of the first gap L1 through the holes 13, a heat absorber 15 for absorbing heat occurring in the fuel cell 11, and a heat radiator 16 disposed so as to face the diaphragm 14 through a predetermined second gap L2. The generated water removing device 10 further has a heat pipe 17 for transmitting the heat absorbed by the heat absorber 15 to the heat radiator 16 and warming the generated water fed to the outside of the first gap through the holes 13.

According to the foregoing construction, the diaphragm 14 atomizes or vaporizes the generated water generated from the fuel cell 11 through the holes 13, and feeds the generated water to the outside of the first gap L1.

In parallel to this operation, the heat occurring in the fuel cell 11 is absorbed by the heat absorber 15, and the heat pipe 17 transmits the heat absorbed by the heat absorber 15 to the heat radiator 16 to warm the generated water fed to the outside of the first gap L1 through the holes 13.

Accordingly, the atomized generated water or the vaporized generated water is surely evaporated by using the heat occurring in the fuel cell 11. Therefore, power generation of the fuel cell is not disturbed by generated water, and thus the power generation efficiency can be kept to a high value.

### [2] First Embodiment

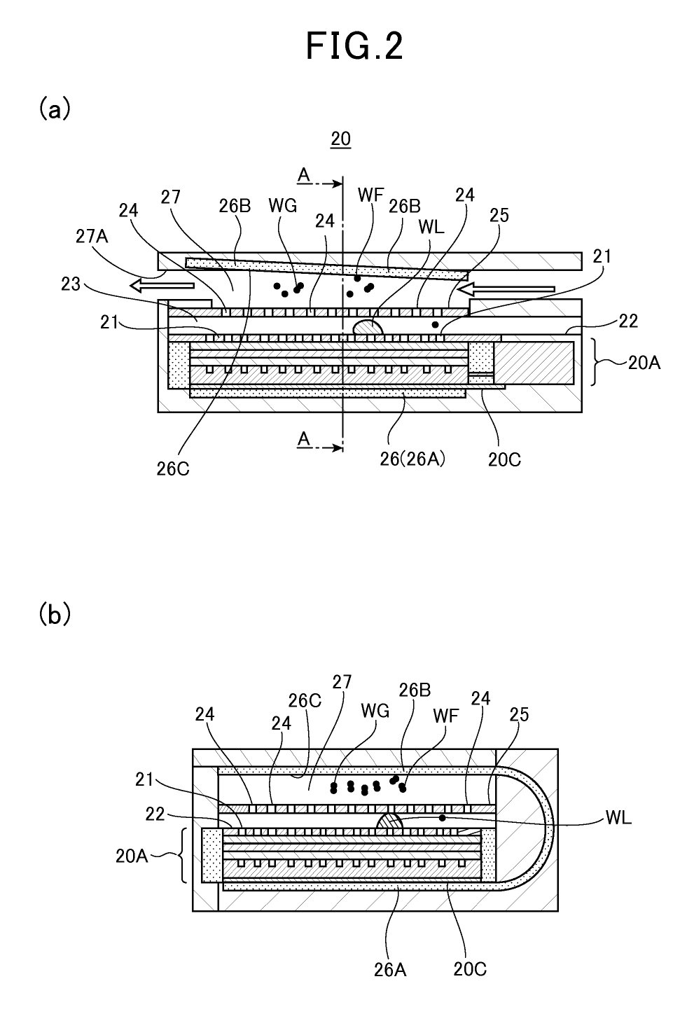

FIG. 2 is a diagram showing the construction of a portable fuel cell unit having a generated water removing device according to a first embodiment.

FIG. 2(a) is a cross-sectional view showing a fuel cell unit containing a discharge passage for atomized or vaporized generated water. FIG. 2(b) is an A-A cross-section of FIG. 2(a).

The fuel cell unit 20 roughly contains a fuel cell 20A having an oxidant electrode side housing 22 which constitutes the fuel cell 20A and has plural air intake holes 21, and a flat-plate type diaphragm 25 which is disposed so as to face the oxidant electrode side housing 22 through an oxidant supply passage 23, has plural holes 24 through which liquid type generated water WL existing in the oxidant supply passage 23 under a normal use state passes and becomes atomized generated water WF or vaporized generated water WG and is vibrated by a piezoelectric element.

An evaporator (heat absorber) 26A of the heat pipe 26 is thermally connected to the surface 20C at the fuel electrode side of the fuel cell 20A.

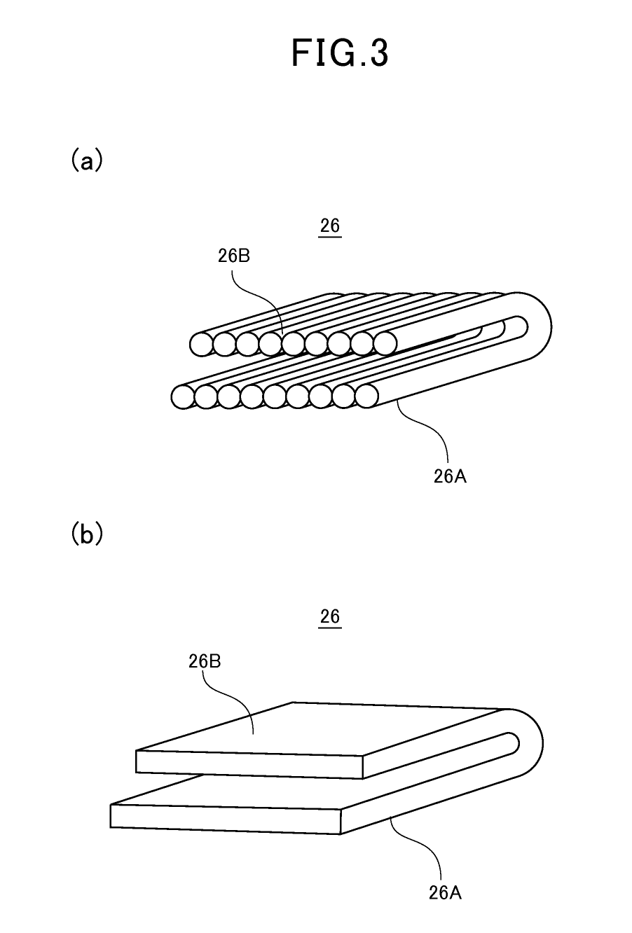

FIG. 3 is a perspective view showing the outlook of the heat pipe. FIG. 3(a) is a perspective view showing the outlook of a heat pipe according to a first example, and FIG. 3(b) is a perspective view showing the outlook of a heat pipe according to a second example.

The heat pipe 26 may be a heat pipe having such a shape that plural cylindrical members are joined to one another in parallel and then folded as shown in FIG. 3(a) or that a flat plate is folded as shown in FIG. 3(b).

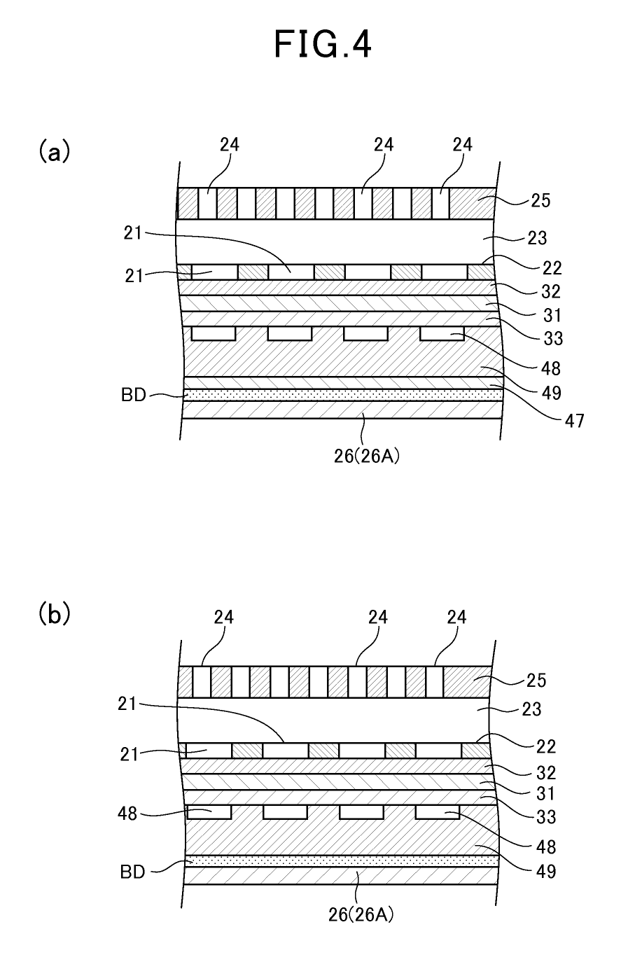

FIG. 4 is a diagram showing a method of thermally connecting the heat pipe to the fuel cell. FIG. 4(a) is a diagram showing a first method of thermally connecting the heat pipe to the fuel cell, and FIG. 4(b) is a diagram showing a second method of thermally connecting the heat pipe to the fuel cell.

According to the first method of thermally connecting the heat pipe to the fuel cell, it is considered that the heat pipe 26 is adhesively attached to a fuel electrode side housing 47 through adhesive agent BD having high thermal conductivity as shown in FIG. 4(a).

Furthermore, according to the second method of thermally connecting the heat pipe to the fuel cell, it is considered that the heat pipe 26 is adhesively attached through adhesive agent having high thermal conductivity to a porous spacer 49 through which fuel gas can pass.

Still furthermore, according to a third method of thermally connecting the heat pipe to the fuel cell, it is considered that the heat pipe is fixed to the fuel electrode side housing 47 or the like by screws.

An evaporator 26A of the heat pipe 26 absorbs heat (exhaust heat) generated when the fuel cell 11 generates power, and transfers the heat to a condenser (heat radiator) 26B. At this time, the condenser 26B is disposed at a side to which atomized generated water WF or vaporized generated water WG passes through the holes 24 of the diaphragm 25. Therefore, the condenser 26B warms the generated water WF or WG which has passed and atomized or vaporized through the diaphragm 25, thereby promoting evaporation of these generated water.

The gap between the diaphragm 25 and the condenser 26B of the heat pipe 26 serves as a generated water discharge path 27, and a surface 26C of the heat pipe 26 which faces the diaphragm 25 functions as a reflection plate for reflecting sound waves and thus reflects an acoustic beam generated by the diaphragm 25, whereby an acoustic stream flowing in a direction of an arrow A occurs.

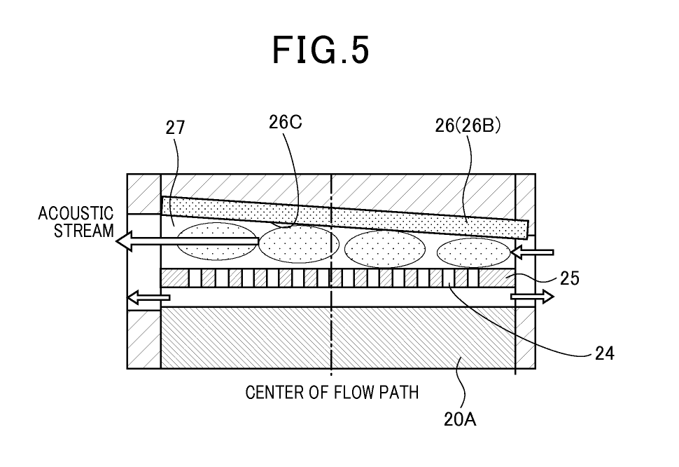

FIG. 5 is a diagram showing the principle of the acoustic stream.

Here, the acoustic stream will be described.

The acoustic stream is a stationary stream of fluid which is generated by acoustic (sound) field.

When the acoustic stream is generated, the surface 26C of the heat pipe 26 is sloped so that the cross-sectional area of the flow path of the generated water discharge path 27 constructed by the diaphragm 25 and the surface 26C of the heat pipe 26 facing the diaphragm 25 gradually increases along the flow direction of the acoustic stream, that is, the shape of the generated water discharge path 27 as the flow path of the acoustic stream is set to be asymmetrical with respect to the center of the flow path.

As a result, when the diaphragm 25 and the surface 26C of the heat pipe 26 which functions as a reflection plate and confronts the diaphragm 25 are disposed to confront each other and the diaphragm 25 is made to vibrate so that standing waves in an ultrasonic wave band occur, resonant air columns occur between the diaphragm 25 and the surface 26C of the heat pipe 26 which faces the diaphragm 25, and in connection with this resonant air columns, eddy flow occurs between the diaphragm 25 and the surface 26C of the heat pipe 26 facing the diaphragm 25.

When the resonant air column occurs between the diaphragm 25 and the surface 26C facing the diaphragm 25 of the heat pipe 26, the sound pressure is gradually stronger from the left side to the right side in the generated water discharge path 27 in FIG. 5, so that a gradient occurs in acoustic pressure. Accordingly, a stream of fluid in the flow path constructed as the generated water discharge path 27 flows from a higher acoustic pressure side to a lower acoustic pressure side (from right to left in FIG. 5). This stream is the acoustic stream.

The generated water WF and WG which are atomized and vaporized by the diaphragm 25 and warmed by the condenser 26B in the fuel cell unit 20 is discharged and removed from a discharge port 27A to the outside of the fuel cell unit 20 by the acoustic stream occurring as described above.

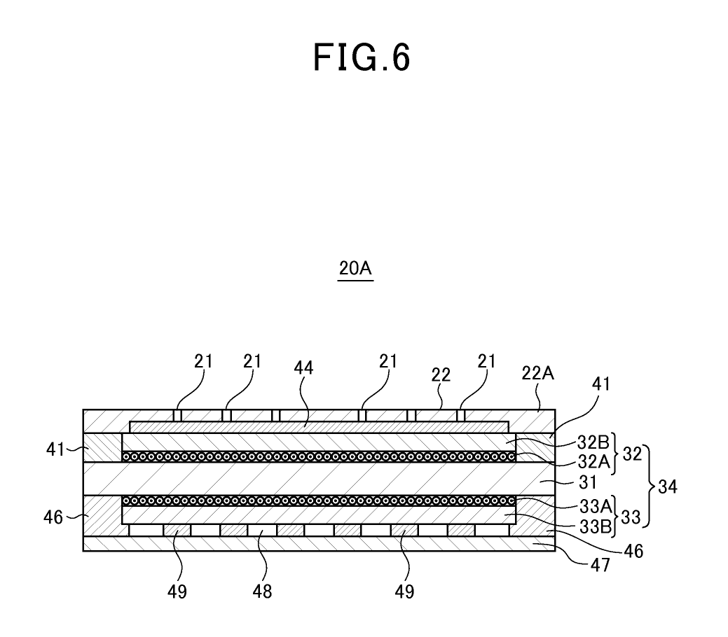

FIG. 6 is a diagram showing the construction of the fuel cell.

The fuel cell 20A has a film/electrode joint member 34 configured by disposing an oxidant electrode 32 and a fuel electrode 33 at both the sides of an electrolytic layer 31. Here, the oxidant electrode 32 functions as an oxidant electrode, and the fuel electrode 33 functions as an anode electrode.

The oxidant electrode 32 is supplied with air containing oxygen as oxidant.

The fuel electrode 33 is supplied with aqueous methanol solution or pure methanol (hereinafter referred to as “methanol fuel”) by a capillary phenomenon.

As a result, the fuel cell 20A generates electric power through an electrochemical reaction between methanol in methanol fuel stocked in a fuel stock chamber 20B (see FIG. 2) and oxygen in air.

The oxidant electrode 32 has an oxidant electrode catalytic layer 32A and an oxidant electrode base member 32B. The oxidant electrode catalytic layer 32A is joined to the electrolytic layer 31. The oxidant electrode base member 32B is formed of a material having an aeration property. Air passing through the oxidant base member 32B is supplied to the oxidant electrode catalytic layer 32A.

An oxidant electrode side gasket 41 is provided at the peripheral edge portion of the electrolytic layer 31 which is located at the oxidant electrode 32 side. An oxidant electrode side housing 22 is mounted through the oxidant electrode side gasket 41. The oxidant electrode side housing 22 is provided with air intake holes 21 through which air containing oxygen (oxidant gas) as oxidant is taken in and generated water generated through the reaction is discharged as described above.

Oxygen as oxidant flowing from the air intake holes 21 flows into an air chamber 44 constructed by the oxidant electrode 32, the oxidant electrode side gasket 41 and the oxidant electrode side housing 22, and reaches the oxidant electrode base member 32B. It is desired that the oxidant electrode side housing 22 has a water-repellent property.

As the material constituting the oxidant electrode side housing is used metal material such as stainless-based metal, titan-based alloy or the like, or composite material such as acrylic resin, epoxy, glass epoxy resin, silicon, cellulose, Nylon (registered trademark), polyamideimide, polyallyl amide, polyallyl ether ketone, polyimide, polyurethane, polyether imide, polyether ether ketone, polyether ketone ether ketone ketone, polyether ketone ketone, polyether sulfone, polyethylene, polyethylene glycol, polyethylene terephthalate, polyvinyl chloride, polyoxymethylene, polycarbonate, polyglycolic acid, polydimethylsiloxane, polystyrene, polysulfone, polyvinyl alcohol, polyvinyl pyrrolidone, polyphenylene sulfide, polyphthalamide, polybutylene terephthalate, polypropylene, polyvinyl chloride, polytetrafluoroethylene, hard polyvinyl chloride or the like.

Next, a fuel electrode side gasket 45 will be described.

The fuel electrode side gasket 45 of this embodiment is constructed by a gas-liquid separating filter as a whole. The fuel electrode side gasket 45 formed by the gas-liquid separating filter transmits gas generated at the fuel electrode 33 therethrough. On the other hand, the fuel electrode side gasket 45 has a gas-liquid separating function for blocking methanol fuel. A material for making the fuel electrode side gasket 45 develop the gas-liquid separating function may be a porous material such as woven cloth, non-woven cloth, mesh, felt or a sponge-like material having open bores.

As a composition constituting the porous material described above may be used polytetrafluoroethylene (PTFE), copolymer of tetrafluoroethylene-perfluoroaklyl vinyl ether(PFA), copolymer of tetrafluoroethylene-hexafluoropropropylene (FEP), copolymer of tetrafluoroethylene-ethylene (ETFE), polyvinylidene fluoride (PVDF), polychlorotrifluoroethylene (PCTFE), copolymer of chlorotrifluoroethylene-ethylene (E/CTFE), polyvinylfluoride (PVF), perfluoro cyclic polymer or the like.

The fuel electrode side gasket 45 formed by the gas-liquid separating filter preferably has a water-repellent property. Here, the water-repellent property is a property of repelling liquid fuel. More specifically, it is defined as a property that the critical surface tension calculated according to Zisman plot is lower than the surface tension of the liquid fuel.

The fuel electrode 33 has a fuel electrode catalytic layer 33A and a fuel electrode base member 33B. The fuel electrode catalytic layer 33A is joined to the electrolytic layer 31. The fuel electrode base member 33B is formed of a porous material.

Methanol fuel passing through the fuel electrode base member 33B by the capillary phenomenon is supplied to the fuel electrode catalytic layer 33a. The fuel electrode base member 33B is preferably formed of an electrical conductive material having hydrophilicity. Here, the hydrophilicity described above is a property of fitting in liquid fuel. More specifically, it is defined as a property that the critical surface tension calculated according to Zisman plot is higher than the surface tension of the liquid fuel. As the electrical conductive material having hydrophilicity is used carbon paper, carbon felt, carbon cloth, a material obtained by coating each of these materials with hydrophilic coating, a material obtained by forming uniform minute holes in a sheet of titan-based alloy or stainless-based alloy through etching and then coating the resultant with corrosion-proof electrical conductive coating (for example, noble metal such as gold, platinum or the like) or the like.

A fuel electrode side gasket 46 is provided at the peripheral edge portion of the electrolytic layer 31 at the fuel electrode 33 side. A fuel electrode side housing 47 is mounted through the fuel electrode side gasket 46, and a fuel chamber 48 in which methanol fuel is stocked is constructed by the fuel electrode 33, the fuel electrode side gasket 46 and the fuel electrode side housing 47. A spacer 49 is provided to the fuel chamber 48.

The methanol fuel stocked in the fuel chamber 48 is directly supplied to the fuel electrode 33. The details of the fuel electrode side gasket 46 will be described later.

It is desired that the fuel electrode side housing 47 has characteristics such as resistance to methanol, acid resistance, mechanical rigidity, etc. Furthermore, it is desirable that the fuel electrode side housing 47 has hydrophilicity. The fuel electrode side housing 47 is provided with a fuel suction unit (not shown) for sucking methanol fuel from a fuel tank (not shown) or the like provided at the outside of the fuel cell 20A, and methanol fuel is supplemented into the fuel chamber 38 as required.

The materials described with respect to the oxidant electrode side housing 22 may be used as the material constituting the fuel electrode side housing 47.

Furthermore, the distance between the fuel electrode 33 and the fuel electrode side housing 47 is kept by the spacer 49. The fuel electrode 33 is pressed against the electrolytic layer 31 by the spacer 49, so that the contact between the fuel electrode 33 and the electrolytic layer 31 is enhanced.

It is desired that the spacer 49 provided in the fuel chamber 48 has characteristics such as methanol resistance, acid resistance, mechanical rigidity, etc. Furthermore, when the spacer 49 is shaped to segmentalize the fuel electrode 33, it is desired that generated gas can pass through the spacer, and thus porous material may be used. For example, as the spacer 49 may be used porous material such as woven cloth, non-woven cloth, mesh or sponge-like material having open bores, which are formed of polyethylene, nylon (registered trademark), polyester, rayon, cotton, polyester/rayon, polyester/acryl, rayon/polychlal or the like, or organic solid of boron nitride, silicon nitride, tantalum carbide, silicon carbide, zeolite, attapulgite, zeolite, silicon oxide, titan oxide or the like in addition to the same porous material as the gas-liquid separating filter described above.

A material which is light in weight and has a high Young's modulus, for example, aluminum is preferably used for the diaphragm 25.

However, when it is formed of metal, duralumin, stainless or titan may be used, when it is formed of ceramic material, alumina, barium titanate, ferrite, silicon dioxide, zinc oxide, silicon carbide or silicon nitride may be used, and when it is formed of plastic material, fluorocarbon resin, polyphenyl sulfide resin, polyether sulfone resin, polyimide, polyacetal, or ethylene-vinylalcohol copolymer (EVOH) may be used.

It is preferable that the thickness of the diaphragm 25 is set to 1.0 mm or less.

The piezoelectric element is preferably formed of a material having a large piezoelectric constant, for example, lead zirconate titanate (PZT). However, piezoelectric ceramics such as lithium tantalite (LiTa₃), lithium niobate (LiNbO₃), lithium tetraborate (Li₂B₄O₇) or the like, or crystalline quartz (SiO₂) may be used.

Here, gas (air or oxygen) supplied to the oxidant electrode 32 is fed by vibration of the diaphragm 25. Vibration energy is applied to water generated by the oxidant electrode 32 (generated water) by the diaphragm 25, whereby the generated water is atomized or vaporized, and then the generated water is discharged to the outside of the oxidant supply passage 23.

In this case, the distance between the diaphragm 25 and the oxidant electrode side housing 22 is preferably set in the range from 0.1 mm to 5.0 mm which the diaphragm 25 comes into contact with generated water on the oxidant electrode side housing 22.

Here, the vibration frequency of the diaphragm 25 based on the piezoelectric element may be suitably selected from an ultrasonic wave band, an audio frequency band and a low frequency band. The audio frequency band and the low frequency band have a merit that the energy loss is smaller than the ultrasonic wave band. Furthermore, the ultrasonic wave band and the low frequency band have a merit that it is harder for a user to recognize noises as compared with the audio frequency band.

The surface 25A of the diaphragm 25 preferably has hydrophilicity, and the surface 22A of the oxidant electrode side housing 22 at the diaphragm 25 side and the back surface 25B of the diaphragm 25 are preferably water-repellent.

The surface 25A of the diaphragm 25 may be subjected to a surface treatment so that coating having hydrophilicity such as titan oxide coating or the like may be formed on the surface 25A of the diaphragm 25. The coating having hydrophilicity is not limited to titan oxide, but silicon nitride or iron oxide may be used.

Furthermore, the surface 22A of the oxidant electrode side housing 22 and the back surface 25B of the diaphragm 25 may be subjected to a surface treatment for forming coating having a water-repellent property such as PTFE (polytetrafluoroethylene) or the like. The coating having the water-repellent property is not limited to PTFE, but it may be formed of FEP (copolymer of tetrafluoroethylene and hexafluoropropylene) or PFA (copolymer of tetrafluoroethylene and perfluoroalkyl vinyl ether.

As described above, generated water generated from the oxidant electrode 32 having the water-repellent surface adheres to the surface 25A of the hydrophilic diaphragm 25 having hydrophilicity. The generated water moving from the oxidant electrode 32 to the diaphragm 25 hardly leaks to the outside because of surface tension. By vibrating the diaphragm 25 with ultrasonic waves, the water adhering to the diaphragm 25 is atomized or vaporized, passes through the holes 24 in the form of mist (water droplet) or gaseous water, reaches the back surface 25B of the diaphragm 25, and is removed by air flowing along the water-repellent back surface 25B without re-adhering to the back surface 25B of the diaphragm 25.

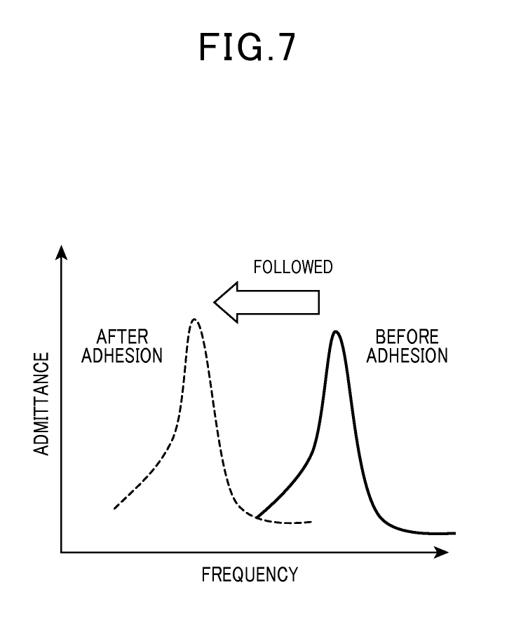

FIG. 7 is a diagram (part 1) showing frequency variation of the piezoelectric element.

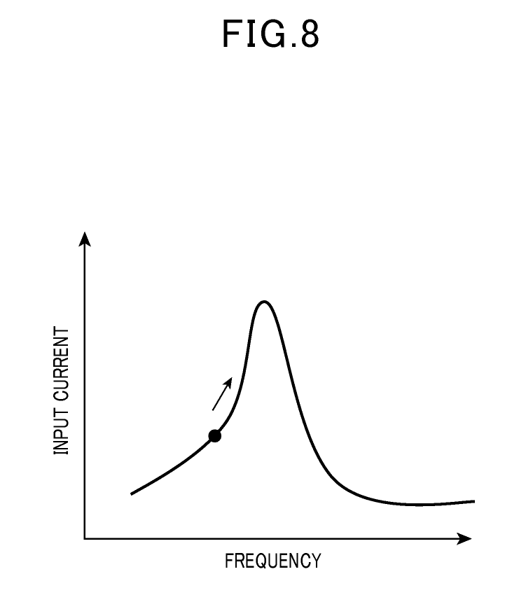

FIG. 8 is a diagram (part 2) showing the frequency variation of the piezoelectric element.

The fuel cell 20A may be provided with a control circuit for controlling the vibration of the diaphragm 25 and giving the resonance frequency of the diaphragm 25.

In this case, when the generated water adheres to the diaphragm 25, the resonance frequency concerned varies in accordance with the adhesion amount of the generated water. Therefore, the control circuit performs the control so as to fit to the resonance frequency after the generated water adheres as shown in FIG. 7. For example, when a piezoelectric element is used as the control circuit, a frequency at which input current is maximum corresponds to the resonance frequency. Therefore, as shown in FIG. 8, a maximum value at which the input current is maximum is determined, and it is set to the resonance frequency.

In the foregoing description, the piezoelectric element is used as means for vibrating the diaphragm 25, however, a magnetostrictor may be used in place of the piezoelectric element. Furthermore, it is desired that the piezoelectric element and the magnetostrictor are made water-repellent with coating.

Next, a method of controlling the fuel cell according to this embodiment will be described.

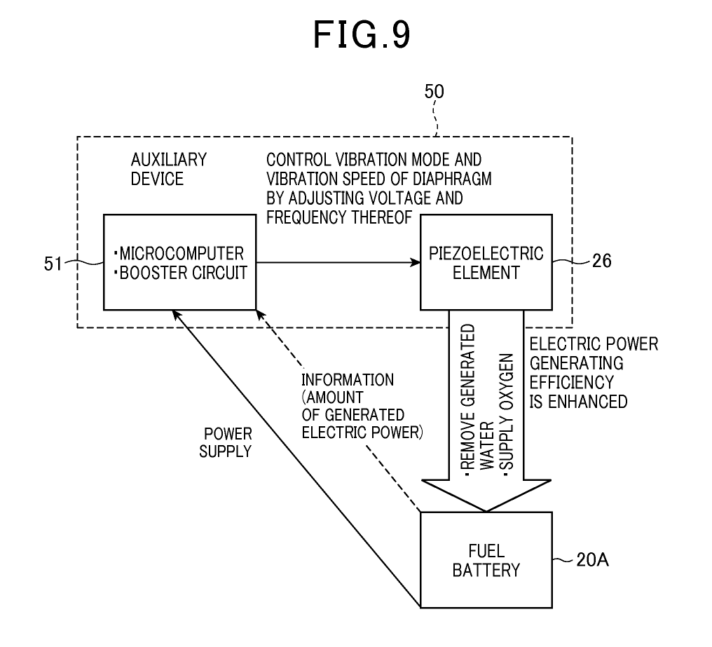

FIG. 9 is a functional block diagram showing a fuel cell unit according to a first embodiment.

Here, a microcomputer/booster circuit 51 and a piezoelectric element are described as auxiliary devices 50 for controlling the fuel cell 20A. However, these auxiliary devices may be designed to be installed in the fuel cell 20A.

The microcomputer/booster circuit 51 supplies the piezoelectric element with a control signal for controlling the vibration mode and the vibration speed of the diaphragm 25 by adjusting the voltage and frequency thereof. In this case, the voltage waveform applied to the piezoelectric element by the microcomputer/booster circuit 51 is a sine wave, a rectangular wave, a triangular wave, a saw tooth wave or the like in the ultrasonic wave band.

The piezoelectric element vibrates the diaphragm 25 disposed in the fuel cell 20A to supply oxygen and remove generated water, so that the power generation efficiency of the fuel cell 20A can be enhanced.

In this case, the microcomputer/booster circuit 51 may be supplied with power from the fuel cell 20A as shown in FIG. 7, or supplied with power from an external power source (not shown).

Furthermore, information on the amount of generated power may be notified from the fuel cell 20A to the microcomputer/booster circuit 51. Here, when the amount of generated power is larger than a desired amount, the microcomputer/booster circuit 51 reduces the voltage to be applied to the piezoelectric element to reduce the supply amount of oxygen as oxidant, thereby reducing the amount of generated power. On the other hand, when the amount of generated power is smaller than a desired amount, the voltage to be applied to the piezoelectric element is increased to increase the supply amount of oxygen as oxidant, thereby increasing the amount of generated power.

The microcomputer/booster circuit 51 may adjust the distance between the oxidant electrode side housing 22 and the diaphragm 25 by varying the vibration amplitude of the piezoelectric element to vary the removing amount of generated water and the air supply amount, thereby adjusting the power generation efficiency. Furthermore, when the diaphragm 25 has plural resonance frequencies, the microcomputer/booster circuit 51 may change the vibration mode by frequency adjustment, and adjust the supply amount of oxidant and the evaporation amount of generated water. In order to reduce the power consumption, the operation may be intermittently performed during only a required time period.

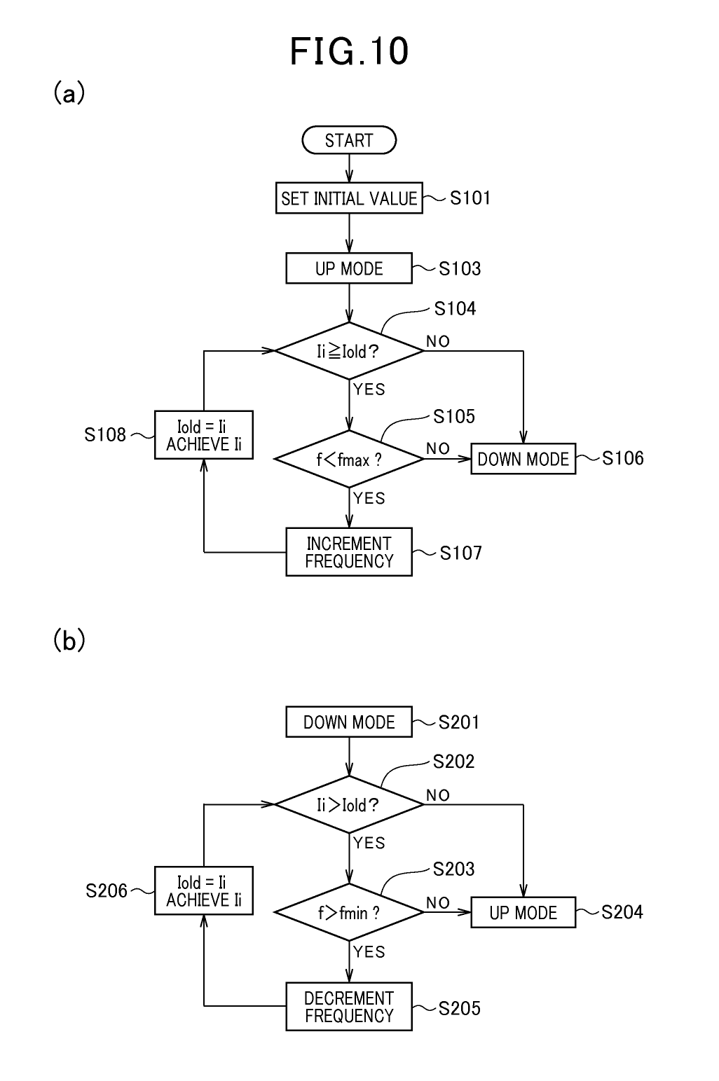

FIG. 10 is a flowchart showing the control processing of the fuel cell.

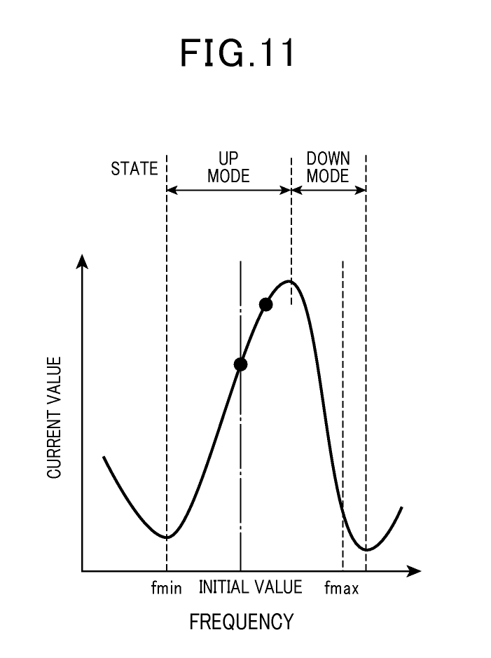

FIG. 11 is a diagram (part 3) showing the frequency variation of the piezoelectric element.

Next, a method of controlling the diaphragm 25 of the piezoelectric element will be described with reference to FIGS. 10 and 11. The processing described below is executed by the microcomputer/booster circuit 51 (see FIG. 9) for controlling the piezoelectric element.

First, the microcomputer/booster circuit 51 sets an initial value of the frequency of the piezoelectric element (step S101). For example, 60 kHz is set as the frequency (f) at the initial time of the piezoelectric element.

The microcomputer/booster circuit 51 measures a current value at the initially set frequency (f) of the piezoelectric element, and substitutes this value into a current value (Ii) and a current value (Iold). The current value (Ii) represents a current value which is updated every time, and the current value (Iold) represents a previously measured current value. At the first measurement time, the same value obtained through the measurement is stored in the current value (Ii) and the current value (Iold).

In the following description, a mode in which the frequency is set to be higher than the previously detected frequency is referred to as UP mode, and a mode in which the frequency is set to be lower than the previously detected frequency is referred to as DOWN mode. In this case, a range in which the frequency is increased and reduced is set to the range between preset maximum frequency (fmax) and minimum frequency (fmin) as shown in FIG. 11. The maximum frequency (fmax) and the minimum frequency (fmin) are set so that the range contains a range in which the resonance frequency is estimated to vary in accordance with the adhering amount of generated water as shown in FIG. 7.

First, the microcomputer/booster circuit 51 shifts the processing to the UP mode (step S103).

Next, the microcomputer/booster circuit 51 determines whether the current value (Ii) is equal to or more than the previous current value (Iold) (step S104).

When the current value (Ii) is equal to or more than the previous current value (Iold) in the determination of the step S104 (step S104; Yes), the microcomputer/booster circuit 51 determines whether the current frequency (f) is smaller than the preset maximum frequency (fmax) shown in FIG. 11 (step S105).

When the current frequency (f) is smaller than the maximum frequency (fmax) in the determination of step S105 (step S105; Yes), the microcomputer/booster circuit 51 increments the frequency (step S107), substitutes the present current value (Ii) into the previous current value (Iold), substitutes the current value after the increment into the current value (Ii) (step S108), and returns to the processing of step S104.

When the current frequency (f) is not smaller than the maximum frequency (fmax), that is, the current frequency (f) is equal to or more than the maximum frequency (fmax) in the determination of step S105 (step S105; No), the microcomputer/booster circuit 51 shifts the processing to DOWN mode processing (step S201) shown in FIG. 10(b).

Subsequently, the microcomputer/booster circuit 51 determines whether the current value (Ii) is larger than the previous current value (Iold) (step S202).

When the current value (Ii) is larger than the previous current value (Iold) in the determination of step S202 (step S202; Yes), the microcomputer/booster circuit 51 determines whether the current frequency (f) is larger than the preset minimum frequency (fmin) shown in FIG. 11 (step S203).

When the current frequency (f) is larger than the minimum frequency (fmin) in the determination of step S203 (step S203; Yes), the microcomputer/booster circuit 51 decrements the frequency (step S205).

Subsequently, the microcomputer/booster circuit 51 substitutes the present current value (Ii) into the previous current value (Iold), substitutes the current value after the decrement into the current value (Ii) (step S205), and returns to the processing of the step S202.

On the other hand, when the current frequency (f) is not larger than the minimum frequency (fmin), that is, the current frequency (f) is equal to or less than the minimum frequency (step S203; No), the microcomputer/booster circuit 51 shifts the processing to the UP mode (step S204). That is, the microcomputer/booster circuit 51 shifts the processing to the step S103 shown in FIG. 10(a), and executes the same processing.

As described above, the microcomputer/booster circuit 51 shifts to the UP mode or the DOWN mode on the basis of the frequency and the current value which are just previously detected, and repeats this processing, whereby the frequency of the piezoelectric element is set to the optimum value.

As a result, according to the fuel cell unit 20 of this embodiment, the diaphragm 25 can be driven in conformity with a power generation state, and thus a generation state of generated water. Accordingly, vibration energy is efficiently applied to generated water WL under liquid state in the oxidant supply passage 23 so that the generated water WL is changed to atomized generated water WF or vaporized generated water WG, and the generated water WF or the generated water WG which are atomized or vaporized while passing through the holes 24 can be removed to the outside of the oxidant supply passage 23.

Accordingly, when the atomized generated water WF or the vaporized generated water WG is removed, these generated water does not flow into the oxidant supply passage 23, so that it does not obstruct the flow of air as oxidant gas.

Furthermore, the oxidant gas can be efficiently made to flow through the oxidant supply passage 23 by diffusion of air in the oxidant supply passage 23 and the acoustic stream caused by the vibration of the diaphragm 25.

Accordingly, generated water exuding to the air intake holes 21 in connection with the power generation of the fuel cell 20A, and thus generated water under liquid state which exists in the oxidant supply passage 23 is quickly removed, whereby oxygen as oxidant can be efficiently supplied, and thus the power generation efficiency of the fuel cell 20A can be enhanced.

Furthermore, the surface 25A of the diaphragm 25 is hydrophilic, and the surface 22A of the oxidant electrode 32 is water-repellent. Therefore, the generated water easily moves from the surface of the fuel cell 20A (the oxidant electrode side housing 22) to the diaphragm 25, and thus the contact area between the generated water and the diaphragm 25 increases. As a result, energy is easily transferred and the generated water can be more efficiently removed.

Still furthermore, when the inside of the electrolytic layer 31 is resonated by excitation of the diaphragm 25, water adhering to the surface of the oxidant electrode side housing 22 or carbon dioxide adhering to the surface of the surface film of the fuel electrode 33 can be diffused to the flow path, so that the power generation efficiency can be more enhanced.

### [3] Second Embodiment

In the first embodiment described above, when an acoustic stream occurs, the surface 26C of the heat pipe 26 is inclined so that the flow path cross-sectional area of the generated water discharge path 27 constructed by the diaphragm 25 and the surface 26C facing the diaphragm 25 of the heat pipe 26 gradually increases along the flowing direction of the acoustic stream. However, in this second embodiment, the surface 26C of the heat pipe 26 is disposed in parallel to the diaphragm 25, and an acoustic stream is generated by heat radiation fins which correspond to the condenser 26B of the heat pipe 26 and are vertically provided to the surface 26C.

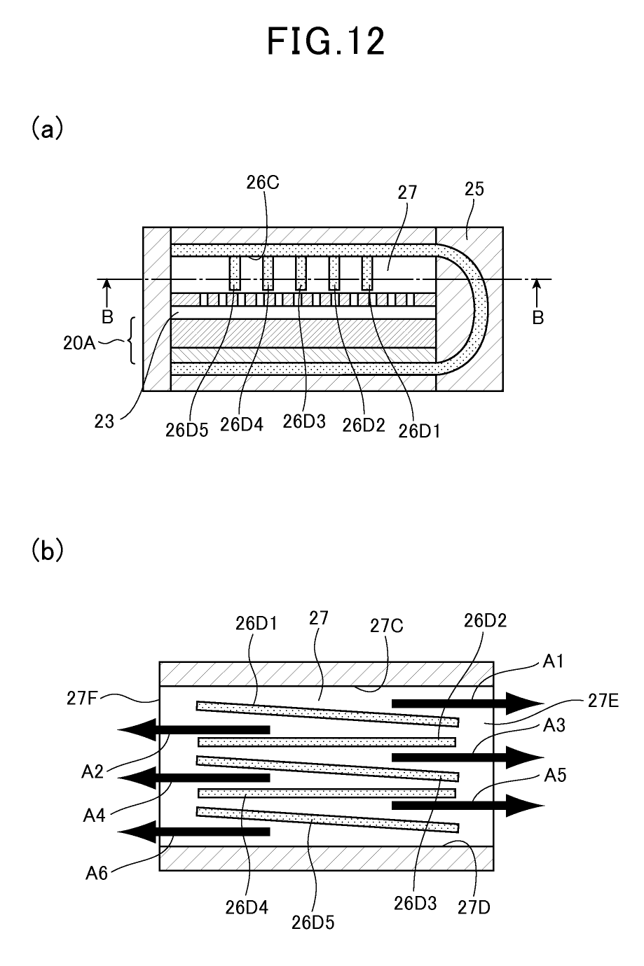

FIG. 12 is a diagram showing the second embodiment. In FIG. 12, the same parts as the first embodiment shown in FIG. 2(b) are represented by the same reference numerals.

As shown in FIG. 12(a), five heat radiation fins 26D1 to 26d5 are vertically provided to the surface 26C corresponding to the condenser 26B of the heat pipe 26.

In this case, the heat radiation fin 26D1 is disposed to slope in the generated water discharge path 27 so that the distance between the heat radiation fin 26D1 and one wall 27C constituting the generated water discharge path 27 increases as it approaches to the right side in FIG. 12(b).

The same is applied to the heat radiation fins 26D3 and 26D5.

On the other hand, the heat radiation fins 26D2 and 26D4 are arranged in parallel to the one wall 27c constituting the generated water discharge path 27.

As a result, in a direction from left to right in FIG. 12(b), the gap distance between the wall 27C and the heat radiation fin 26D1 gradually increases, the gap distance between the heat radiation fin 26D1 and the heat radiation fin 26D2 gradually decreases, the gap distance between the heat radiation fin 26D2 and the heat radiation fin 26D3 gradually increases, the gap distance between the heat radiation fin 26D3 and the heat radiation fin 26D4 gradually decreases, the gap distance between the heat radiation fin 26D4 and the heat radiation fin 26D5 gradually increases, and the gap distance between the heat radiation fin 26D5 and the other wall 27D constituting the generated water discharge path 27 gradually decreases.

As a result, an acoustic streamA1 occurring between the wall 27C and the heat radiation fin 26D1 flows in a direction from left to right. An acoustic stream A2 occurring between the heat radiation fin 26D1 and the heat radiation fin 26D2 flows in a direction from right to left. An acoustic stream A3 occurring between the heat radiation fin 26D2 and the heat radiation fin 26D3 flows in a direction from left to right. An acoustic stream A4 occurring between the heat radiation fin 26D3 and the heat radiation fin 26D4 flows in a direction from right to left. An acoustic stream A5 occurring between the heat radiation fin 26D4 and the heat radiation fin 26D5 flows in a direction from left to right. An acoustic stream A6 occurring between the heat radiation fin 26D5 and the other wall 27D constituting the generated discharge path 27 flows in a direction from right to left.

As a result, according to the second embodiment, generated water WF and generated water WG which are atomized or vaporized by the diaphragm 25 and then warmed through the heat radiation fins 26D1 to 26D5 by the condenser 26B are discharged and removed from a first discharge port 27E to the outside of the fuel cell unit 20 by the acoustic streams A1, A3 and A5. Furthermore, the generated water WF and the generated water WG are discharged and removed from a second discharge port 27F to the outside of the fuel cell unit 20 by the acoustic streams A1, A3 and A5.

As described above, according to the second embodiment, as in the case of the first embodiment, the generated water WF and the generated water WG are more quickly discharged and removed to the outside of the fuel cell unit 20, and thus they do not cause degradation of the power generation capability.

### [4] Third Embodiment

In the first embodiment, when an acoustic stream is generated, the surface 26C of the heat pipe 26 is sloped so that the flow-path cross-sectional area of the generated water discharge path 27 constructed by the diaphragm 25 and the surface 26C of the heat pipe 26 which faces the diaphragm 25 of the heat pipe 26 gradually increases along the flow direction of the acoustic stream. According to a third embodiment, the heat pipe is designed to be stepped and an acoustic stream is generated along the stepping direction.

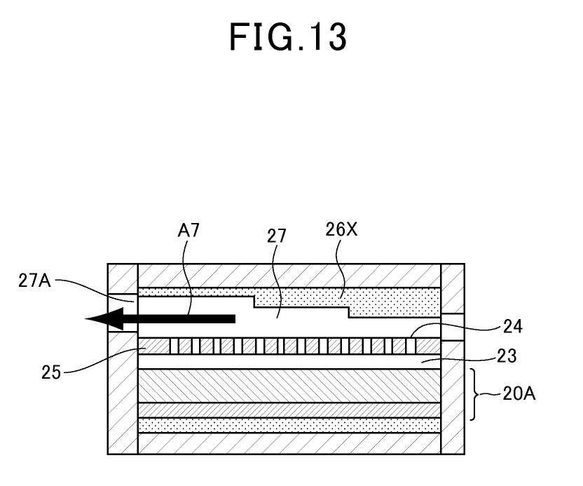

FIG. 13 is a diagram showing a third embodiment. In FIG. 13, the same parts as the first embodiment shown in FIG. 2(a) are represented by the same reference numerals.

As shown in FIG. 13, a heat pipe 26X is stepped to be more thinned along the flow direction of an acoustic stream. In FIG. 13, it is thinner in a direction from right to left.

As a result, as in the case of the first embodiment, acoustic pressure is gradually stronger in a direction from left to right in FIG. 13, and a gradient of acoustic pressure occurs. Accordingly, with respect to fluid in the path, generated water WF and generated water WG which are atomized or vaporized by the diaphragm 25 and warmed by the condenser 26B in the fuel cell unit 20 are discharged and removed from the discharge port 27A to the outside of the fuel cell unit 20 by the acoustic stream flowing from a high acoustic pressure side to a low acoustic pressure side (from right to left in FIG. 13).

In the foregoing description, the generated water removing device of this embodiment is provided to the fuel cell 20a as a single body to construct the fuel cell unit 20. In the following description, a fuel cell having the generated water removing device according to this embodiment is applied to various kinds of electronic equipment.

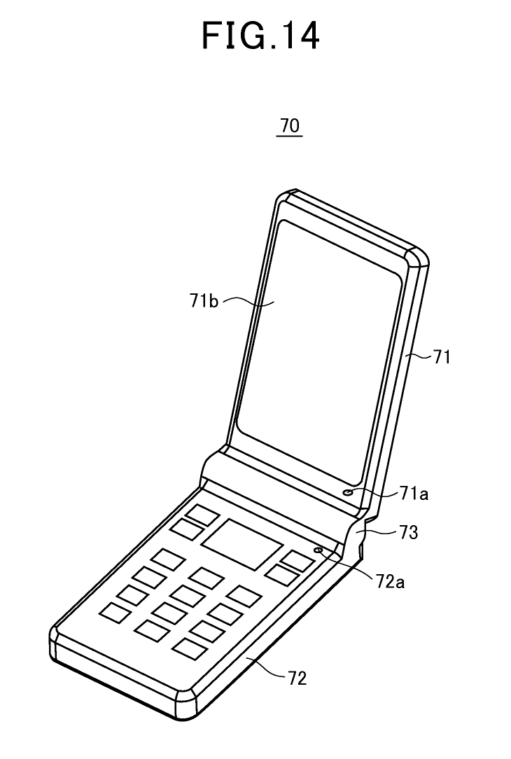

FIG. 14 is a diagram showing a foldable cellular phone terminal containing a fuel cell having the generated water removing device according to the present invention.

In the cellular phone terminal 70, a display side housing 71 and an operation side housing 72 are joined to each other through a hinge mechanism 73 so as to be openable and closable. A main display 71b is provided on the inner surface of the display side housing 71, and a sub display (not shown) is provided on the outer surface. A projection 71a is provided on the inner surface of the display side housing 71 to detect the opening/closing of the display side housing 71 and the operation side housing 72. An opening/closing detection switch 72a is provided on the inner surface of the operation side housing 72 so as to be turned on/off by the projection 71a.

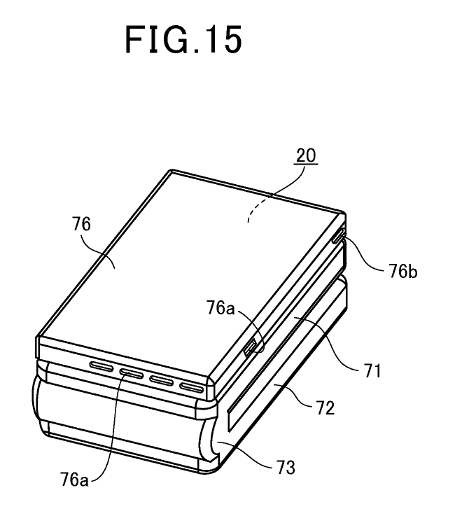

FIG. 15 is a diagram showing a case where a fuel cell is secured to a cellular phone terminal.

In the cellular phone terminal 70, a fuel cell unit 20 having a generated water removing device according to the present invention is secured to the back side of the display side housing 71.

The fuel cell unit 20 is disposed inside a cover 76, and suction ports 76a for sucking air and a discharge port 76b for discharging air are formed in the cover 76.

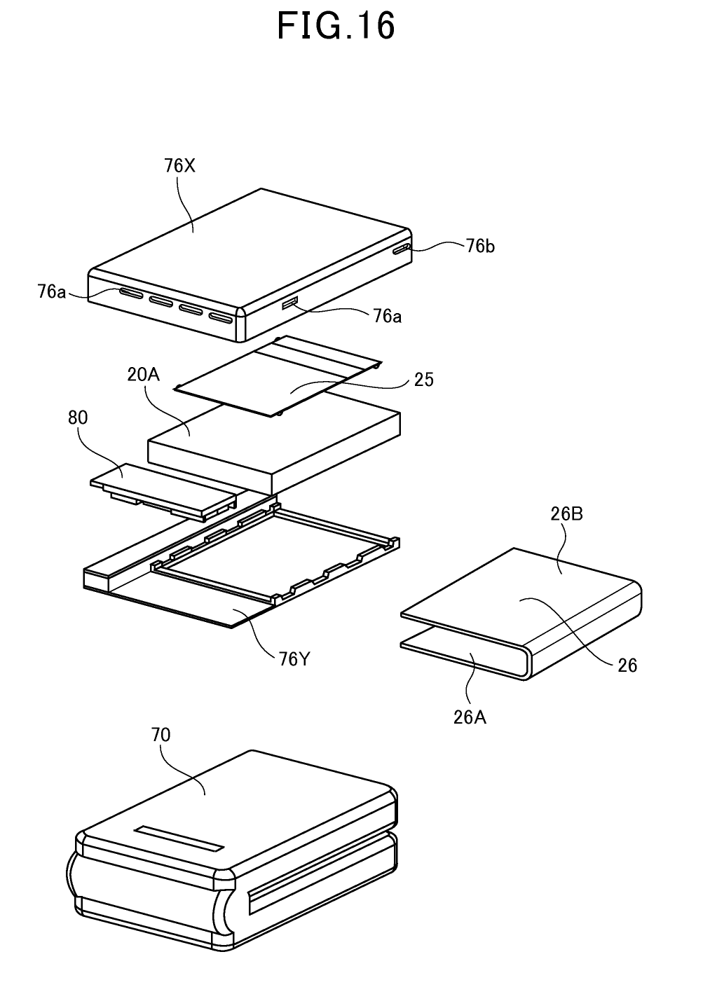

FIG. 16 is an exploded perspective view showing a fuel cell unit mounted in the cover.

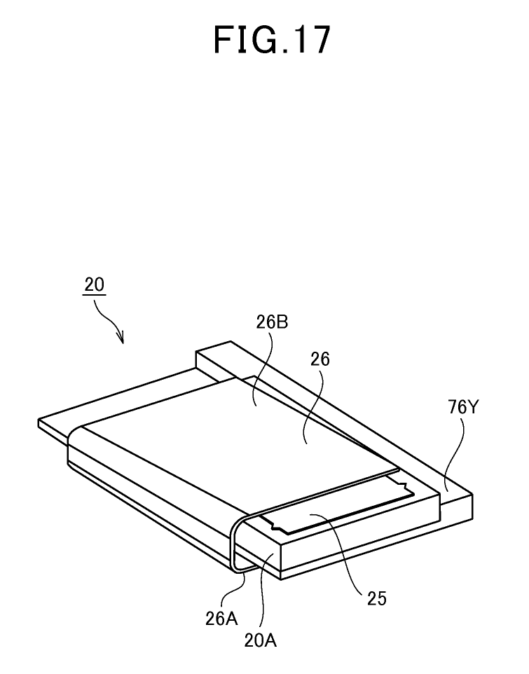

FIG. 17 is a partial assembling diagram when the fuel cell unit is mounted in the cover.

As shown in FIG. 17, the cover 76 has an upper cover 76X and a lower cover 76Y.

The cover 76 contains a control circuit 80 for a fuel cell 20A, the fuel cell 20A, a diaphragm 25 and a heat pipe 26 mounted on the lower cover 76Y. In this case, as shown in FIG. 17, the heat pipe 26 is fixed to the lower cover 76Y while it is thermally joined to the fuel cell 20A and the fuel cell 20a and the diaphragm 25 are sandwiched between an evaporator 26A and a condenser 26B.

Thereafter, the upper cover 76X and the lower cover 76Y are fitted to each other, whereby the fuel cell unit 20 is mounted in the cover 76. The fuel cell is secured to the cellular phone terminal 70, and supplies power to the cellular phone terminal 70.

It should be noted that all the foregoing embodiments and applications are examples and do not limit the present invention. The scope of the present invention is defined not by the description on the above embodiments and examples of constructions, but by the scope of claims, and further the present invention contains all modifications within the meaning and range of equivalents to the scope of claims.

Furthermore, in the fuel cell described above, when generated water accumulates in the oxidant supply path 23, it serves as fluid resistance to air flowing in the oxidant supply path, and a sufficient air supply amount (oxidant supply amount) cannot be secured, so that the power generation efficiency of the fuel cell is lowered.

Therefore, the fuel cell may be configured so that the operation state is switched from a normal operation to a water removing operation at the time point when accumulation of water in the oxidant supply path 23 is detected.

In this case, the time point when water accumulates in the oxidant supply path 23 may be determined on the basis of the magnitude of acoustic pressure in the oxidant supply path 23 which is detected by an acoustic pressure sensor (not shown) disposed in the oxidant supply path 23 and an acoustic pressure detecting circuit to which the output of the acoustic pressure sensor is input.

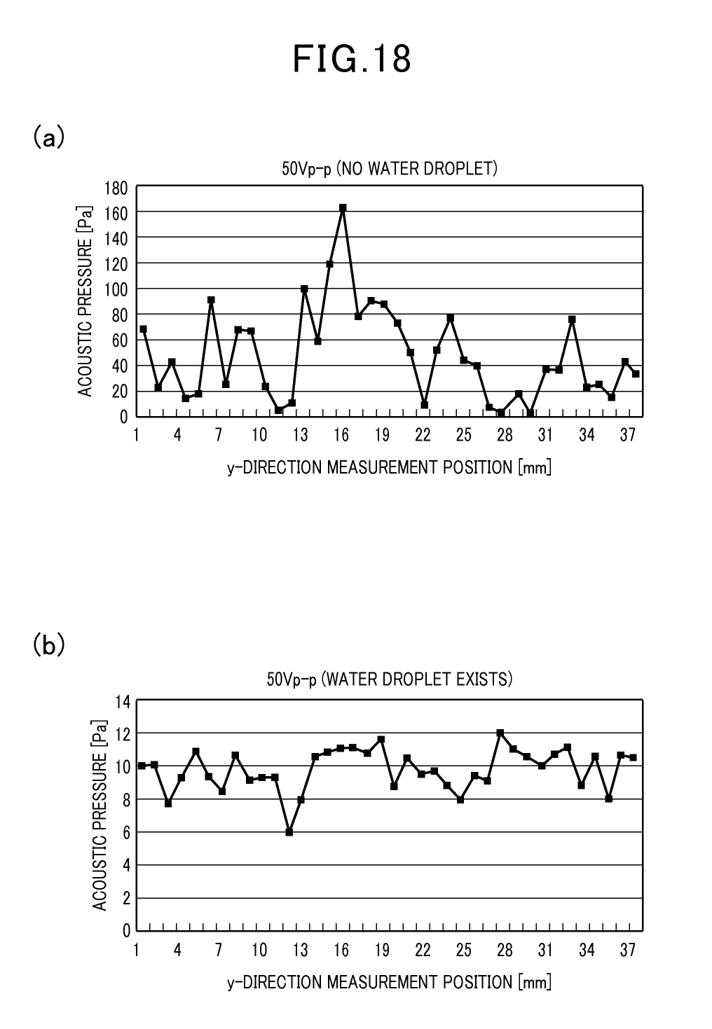

FIG. 18 is a diagram showing an acoustic pressure distribution.

FIG. 18(a) shows an acoustic pressure distribution in a predetermined direction along the oxidant supply path 23 under a state that no water droplet adheres to the diaphragm plate 25, and FIG. 18(b) shows an acoustic pressure distribution in the same direction as the predetermined direction under a state that a water droplet adheres to the diaphragm 25.

As shown in FIG. 18, the acoustic pressure in the oxidant supply path 23 is greatly reduced when any water droplet adheres to the diaphragm 25. Therefore, at the time point when the detected acoustic pressure underruns a predetermined threshold value, generated water can be determined to accumulate in the oxidant supply path 23, so that the diaphragm 25 can be operated at the optimum frequency and voltage to remove the generated water.

As a result, the diaphragm 25 is operated with a frequency and a voltage at which the supply efficiency of oxygen as oxidant to the oxidant electrode 32 is high until generated water accumulates in the oxidant supply path, whereby the power generation efficiency can be increased. In addition, at the time point when generate water causing decrease of the power generation efficiency accumulates, the generated water removing efficiency is increased, whereby a period for which the power generation efficiency is high can be lengthened, so that the effective power generation efficiency can be increased.

In the foregoing description, accumulation of generated water is directly detected, however, a time required for the accumulation of generated water is roughly estimated. For example, a time period for a normal operation (power generating operation) of operating the diaphragm 25 at a frequency and a voltage at which the supply efficiency of oxygen as oxidant to the oxidant electrode 32 is high is set to a first predetermined time (for example, 10 min), a time period for a generated water removing operation of operating the diaphragm 25 at a frequency and a voltage at which the generated water removing efficiency is high is set to a second predetermined time (for example, 10 msec), and the normal operation and the generated water removing operation are alternately switched to each other, whereby the power generation efficiency is maintained.

Three or more acoustic sensors may be disposed in the oxidant supply path 23 to monitor the acoustic pressure distribution in the oxidant supply path 23, whereby the time point at which generated water accumulates in the oxidant supply path 23 is detected.

When generated water is accumulating in the oxidant supply path 23, the resonance frequency in the oxidant supply path 23 varies, and thus current flowing in the piezoelectric element for making the diaphragm 25 vibrate decreases. Accordingly, by detecting this decrease, the control can be shifted from the normal operation control to the generated water removing operation control without using any acoustic sensor.

In this case, in connection with the change from the normal operation control to the generated water removing operation control, the vibrational frequency of the diaphragm 25 varies, the number of nodes and the number of loops of vibration vary, and the positions of the nodes and the positions of the loops shift during this process. In the generated water removing operation control, a water droplet adhering to the diaphragm plate 25 trends to move from the node position to the loop position, and thus water concentrates at the loop position in the vibration after the frequency is changed.

Therefore, in the generated water removing operation control, various positions of the diaphragm 25 are changed from nodes to loops or from loops to nodes by changing the frequency, whereby generated water can be efficiently atomized or vaporized and removed.

Likewise, the switch from the normal operation to the generated water removing operation may be performed by switching the vibrational frequency of the diaphragm 25 from the resonance frequency of the longitudinal vibration mode to the resonance frequency of the transverse vibration mode.

In the foregoing description, the fuel cell having the generated water removing device according to the present invention is used for the cellular phone terminal. However, the fuel cell is not limited to this style, and it may be used as a power source for any electronic equipment such as a charger for charging a cellular phone or the like, AV equipment such as a video camera or the like, a portable game machine, a navigation device, a handy cleaner, a power generator for business, a robot or the like.

Furthermore, a fuel cell can be designed as a flat module by using such a generated water removing device.

The generated water removing device according to the present invention is not limitedly used for a fuel cell, but it may be used in any application other than the application to the power source for any electronic equipment as described above. For example, the generated water removing device according to the present invention may be applied to the surface of an electronic circuit portion constituting electronic equipment so that the electronic circuit portion is cooled by gas (air), water which is being fed.

In the foregoing description, the fuel cell is used as the electrical equipment (electronic equipment). However, the present invention is likewise applicable to any electrical equipment (electronic equipment) insofar as at least water of heat and water occurs in connection with an operation of the electrical equipment (electronic equipment).

### DESCRIPTION OF REFERENCE NUMERALS

10 generated water removing device
11 fuel cell (electrical equipment, electronic equipment)
11A discharge face
13 hole
14 diaphragm
15 heat absorber
16 heat radiator
17 heat pipe
20 fuel cell unit
20A fuel cell
21 air intake hole
22 oxidant electrode side housing
22A surface
23 oxidant supply path
24 hole
25 diaphragm
26 heat pipe
26A evaporator
26B condenser
26C surface
26X heat pipe
27 generated water discharge path
27E first discharge port
27F second discharge port
33B fuel electrode base member
70 cellular phone terminal (electronic equipment)
26D1 to 26D5 heat radiation fin
A1 to A7 acoustic stream
L1 first gap
L2 second gap

1. A generated water removing device for removing generated water generated from electrical equipment, comprising:
a diaphragm that is disposed so as to face a generated water discharge face of the electrical equipment through a predetermined first gap, has a plurality of holes for atomizing or vaporizing the generated water and feeds the generated water to the outside of the first gap through the holes; and
a heat pipe that has a heat absorber for absorbing heat generated in the electrical equipment and a heat radiator disposed so as to face the diaphragm through a predetermined second gap, and transfers heat absorbed by the heat absorber to the heat radiator to warm the generated water fed to the outside of the first gap through the holes.

2. (canceled)

3. (canceled)

4. The generated water removing device according to claim 1, wherein a generated water feeding path is constructed by the diaphragm and a portion of the heat pipe that faces the diaphragm, and a cross-sectional area of the generated water feeding path gradually or stepwise increases along a feeding direction of the generated water.

5. The generated water removing device according to claim 4, wherein the generated water is fed to the outside of the generated water feeding path by an acoustic stream that is generated in the generated water feeding path due to vibration of the diaphragm and reflection of the heat radiator of the heat pipe.

6. The generated water removing device according to claim 1, wherein the heat radiator of the heat pipe has a plurality of heat radiation fins projecting into the second gap.

7. The generated water removing device according to claim 1, wherein a surface of the heat radiator of the heat pipe that is located at the diaphragm side is formed of a hydrophilic material.

8. The generated water removing device according to claim 1, wherein the electrical equipment comprises a fuel cell having an oxidant electrode side housing at an oxidant electrode side, and the generated water discharge face of the electrical equipment is a surface of the oxidant electrode side housing of the fuel cell.

9. The generated water removing device according to claim 8, wherein the fuel cell is mounted in portable electronic equipment.
